(19) United States
(12) Patent Application Publication
(10) Pub. No.: US 2025/0086497 A1
(43) Pub. Date: Mar. 13, 2025

(54) MACHINE LEARNING TRAINING DEVICE, METHOD, AND NON-TRANSITORY COMPUTER READABLE STORAGE MEDIUM

(71) Applicants: Inventec (Pudong) Technology Corporation, Shanghai (CN); INVENTEC CORPORATION, TAIPEI CITY (TW)

(72) Inventors: Po Hsuan HUANG, TAIPEI CITY (TW); Chia-Ching LIN, TAIPEI CITY (TW); Chih-Fan HSU, TAIPEI CITY (TW); Ming-Ching CHANG, TAIPEI CITY (TW); Wei-Chao CHEN, TAIPEI CITY (TW)

(21) Appl. No.: 18/418,335

(22) Filed: Jan. 21, 2024

(30) Foreign Application Priority Data
Sep. 12, 2023 (CN) 202311171704.0

(51) Int. Cl. G06N 20/00

(52) U.S. Cl. CPC G06N 20/00

(57) ABSTRACT

A machine learning training device is disclosed. The machine learning training device includes a virtual hard anchor generation circuit, a classification circuit and a training circuit. The virtual hard anchor generation circuit is configured to generate several virtual hard anchors according to several easy samples classified into several types. The virtual hard anchors respectively correspond to one of the several types. The classification circuit is configured to classify several hard samples into several types according to virtual hard anchors. Parts of the hard samples classified into several types are several clean hard samples. Another parts of the hard samples that are not classified into several types are several noisy hard samples. The training circuit is configured to perform machine learning training according to several easy samples and several clean hard samples.

### CROSS-REFERENCE TO RELATED APPLICATION

This application claims the priority benefit of CHINA Application serial no. 202311171704.0, filed Sep. 12, 2023, the full disclosure of which is incorporated herein by reference.

### FIELD OF INVENTION

The present application relates to a machine learning training device, a machine learning training method, and a non-transitory computer readable storage medium. More particularly, the present application relates to a machine learning training device, a machine learning training method, and a non-transitory computer readable storage medium with deep neural network (deep learning).

### BACKGROUND

In recent years, in the field of machine learning, when performing research on deep neural networks (DNN), it is necessary to rely on the sample sets including labels or annotations. However, the sample set may include noisy samples (i.e. samples with wrong labels or wrong annotations), which will reduce the performance of the machine learning model. Therefore, various noisy label learning (NLL) methods have been proposed. The noisy label learning method aims to find clean samples (i.e. correctly labeled samples).

A method using small loss criterion to perform sample selection is proposed. The sample selection method with small loss criterion treats samples with small classification loss as clean samples and samples with large classification loss as noisy samples. However, a sample with a large classification loss is not necessarily a noisy sample. The sample might cause a large classification loss and is difficult to be learned by a deep neural network due to its complex visual pattern. For example, in machine learning training for classifying aircraft images and ship images, it is difficult for deep neural networks to learn aircraft samples on the water. If only the samples with larger classification losses are regarded as noisy samples and discarded, it will cause inaccurate boundary decision-making in machine learning, overfitting of the model and the performance is reduced. Therefore, a better noisy sample filtering method is one of the problems to be solved in the field.

### SUMMARY

The disclosure provides a machine learning training device. The machine learning training device includes a hallucination hard anchor generation circuit, a classification circuit, and a training circuit. The hallucination hard anchor generation circuit is configured to generate several hallucination hard anchors according to several easy samples. Several easy samples are classified as several types, in which each of several hallucination hard anchors corresponds to one of several types. The classification circuit is coupled to the hallucination hard anchor generation circuit. The classification circuit is configured to classify several hard samples as several types according to several hallucination hard anchors, in which parts of several hard samples which are classified as several types are several clean hard samples, in which another parts of several hard samples which are not classified as several types are several noisy hard samples. The training circuit is coupled to the classification circuit. The training circuit is configured to perform a machine learning training according to several easy samples and several clean hard samples.

The disclosure provides a machine learning training method. The machine learning training method includes the following operations: generating several hallucination hard anchors according to several easy samples, in which several easy samples are classified as several types, in which each of several hallucination hard anchors corresponds to one of several types; classifying several hard samples as several types according to several hallucination hard anchors, in which parts of several hard samples which are classified as several types are several clean hard samples, in which another parts of several hard samples which are not classified as several types are several noisy hard samples; and performing a machine learning training according to several easy samples and several clean hard samples.

The disclosure provides a non-transitory computer readable storage medium, configured to store a computer program, in which when the computer program is executed, one or more processors are executed to perform several operations, in which several operations comprises: generating several hallucination hard anchors according to several easy samples, in which several easy samples are classified as several types, in which each of several hallucination hard anchor corresponds to one of several types; classifying several hard samples as several types according to several hallucination hard anchors, in which parts of several hard samples which are classified as several types are several clean hard samples, in which another parts of several hard samples which are not classified as several types are several noisy hard samples; and performing a machine learning training according to several easy samples and several clean hard samples.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating a machine learning training device according to some embodiments of the present disclosure.

FIG. 2 is a flow chart diagram illustrating a machine learning training method according to some embodiments of the present disclosure.

FIG. 3 is a schematic diagram illustrating a machine learning training method as illustrated in FIG. 2 according to some embodiments of the present disclosure.

FIG. 4 is a schematic diagram illustrating a sample classification according to some embodiments of the present disclosure.

FIG. 5 is a schematic diagram illustrating a generation of hallucination hard anchors according to some embodiments of the present disclosure.

FIG. 6 is a schematic diagram illustrating a generation of hallucination hard anchors according to some embodiments of the present disclosure.

FIG. 7 is a schematic diagram illustrating a sample classification according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The term “coupled” used herein may also refer to “electrically coupled”, and the term “connected” may also refer to “electrically connected”. “Coupled” and “connected” may also refer to Refers to two or several elements that cooperate or interact with each other.

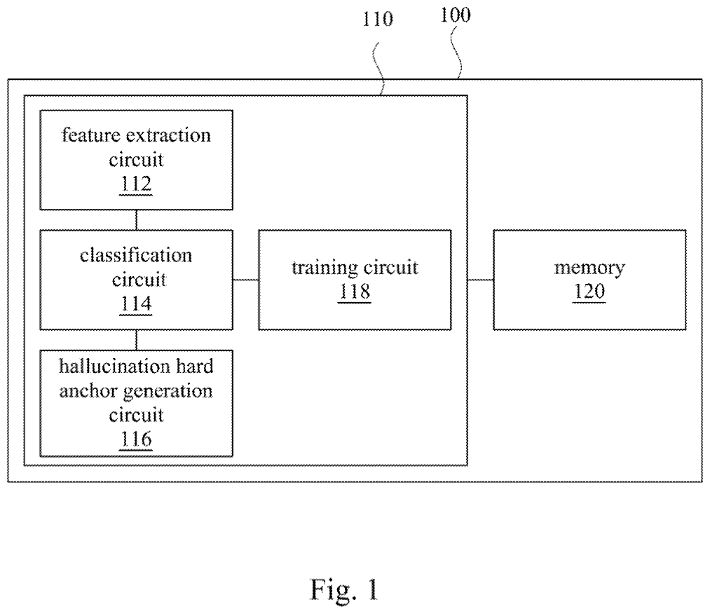

Reference is made to FIG. 1. FIG. 1 is a schematic diagram illustrating a machine learning training device 100 according to some embodiments of the present disclosure. In some embodiments, the machine learning training device 100 includes a processor 110 and a memory 120. In the connection relationship, the processor 110 is coupled to memory 120. The processor 110 includes a feature extraction circuit 112, a classification circuit 114, the hallucination hard anchor generation circuit 116 and a training circuit 118. In the connection relationship, the feature extraction circuit 112 is coupled to the classification circuit 114, the classification circuit 114 is coupled to the hallucination hard anchor generation circuit 116, and the classification circuit 114 is further coupled to the training circuit 118.

The machine learning training device 100 as illustrated in FIG. 1 is for illustrative purposes only, and the embodiments of the present disclosure are not limited to FIG. 1. The machine learning training device 100 may further include other components for operations or are required in the embodiments of the present disclosure. For example, the machine learning training device 100 may further include an output interface (for example, a display panel for displaying information), an input interface (for example, touch panel, keyboard, microphone, scanner or flash memory reader) and a communication circuit (for example, Wi-Fi communication model, Bluetooth communication model, wireless telecommunications network communication model, etc.). In some embodiments, the machine learning training device 100 can be created by a computer, server or processing center.

In some embodiments, the memory 120 may be flash memory, HDD, SSD (solid state drive), DRAM (dynamic random access memory) or SRAM (static random access memory). In some embodiments, the memory 120 may be a device that stores a non-transitory computer readable storage medium with at least one instruction associated with the machine learning training method. The processor 110 can access and execute at least one instruction.

In some embodiments, the processor 110 may be, but is not limited to, a single processor or a collection of several microprocessors, for example, a CPU or a GPU. The microprocessors are electrically coupled to the memory 120 to access and respond to at least one instruction to execute the machine learning training method. For ease of understanding and explanation, the details of the machine learning training method will be described in the following paragraphs.

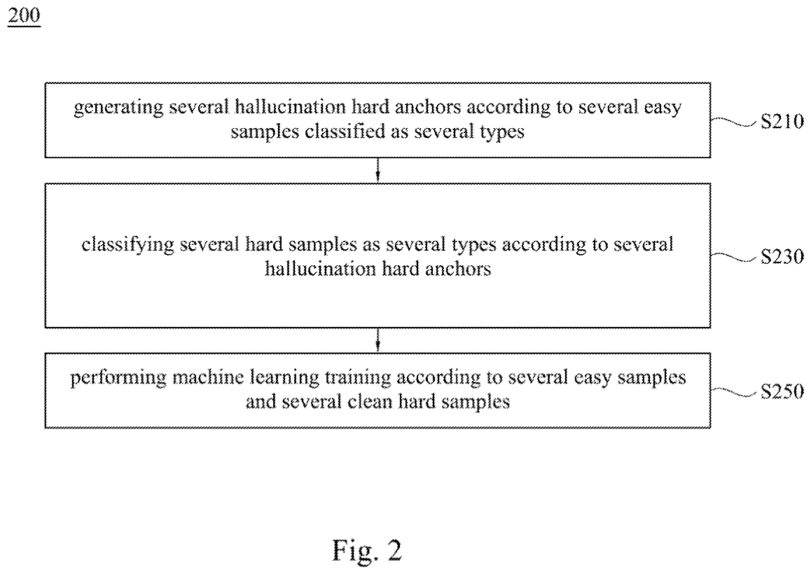

Details of the embodiments of the present disclosure are disclosed below with reference to the machine learning training method 200 in FIG. 2. The machine learning training method 200 in FIG. 2 is applicable to the machine learning training device 100 in FIG. 1. However, the embodiments of the present disclosure are not limited to this.

Reference is made to FIG. 2. FIG. 2 is a flow chart diagram illustrating a machine learning training method 200 according to some embodiments of the present disclosure. However, the embodiments of the present disclosure are not limited thereto.

It should be noted that, the machine learning training method 200 can be applied to a system with the same or similar structure as the machine learning training device 100 in FIG. 1. To make the description simple, the following will take FIG. 1 as an example to for illustrating the machine learning training method 200. However, the embodiments of the present disclosure are not limited thereto the application of FIG. 1.

It should be noted that, in some embodiments, the machine learning training method may also be implemented as a computer program and stored in a non-transitory computer readable storage medium, thereby enabling a computer, electronic device, or the aforementioned processor 110 as shown in FIG. 1, so as to read the non-transitory computer readable storage medium and to execute the operation method. The non-transitory computer readable storage medium can be read-only memory, flash memory, floppy disk, hard disk, optical disk, pen drive, tape, or a database which can be accessed via the Internet, or any non-transitory computer readable storage medium with the same functionality can be easily imagined by a person familiar with the art.

In addition, it should be understood that the operations of the and operation methods mentioned in the embodiments, unless the order is specifically stated, can be adjusted according to actual needs, and can even be executed simultaneously or partially simultaneously.

Furthermore, in different embodiments, these operations can also be adaptively added, replaced, and/or omitted.

Reference is made to FIG. 2. The machine learning training method includes the following operations. The detailed operation method of the machine learning training device 100 in FIG. 1 will be described with reference to the machine learning training method 200 in FIG. 2 below.

In operation S210, several hallucination hard anchors are generated according to several easy samples classified as several types. Each of the several hallucination hard anchors corresponds to one of the several types. In some embodiments, the operation S210 is performed by the hallucination hard anchor generation circuit 116 as illustrated in FIG. 1.

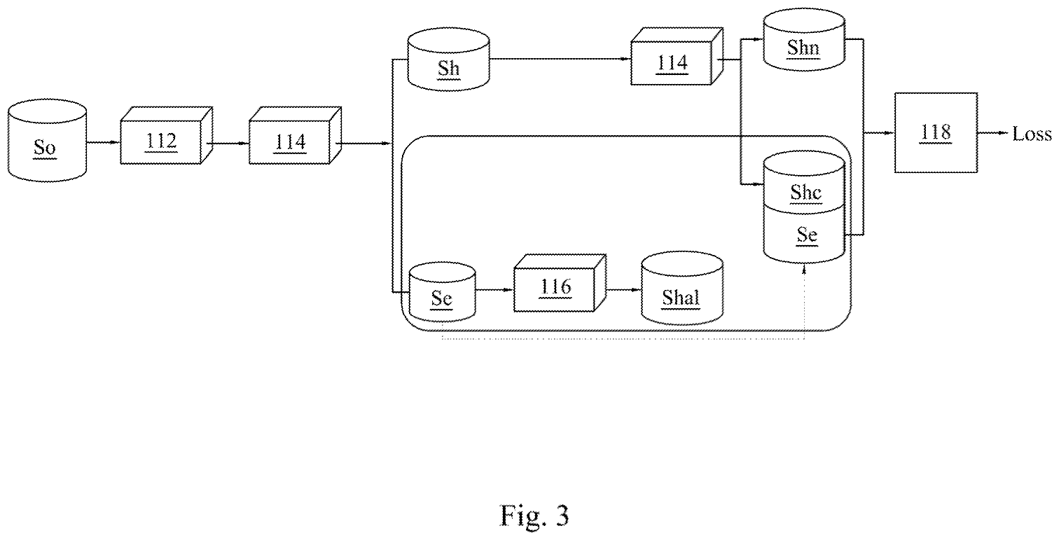

Reference is made to FIG. 3 together. FIG. 3 is a schematic diagram illustrating a machine learning training method 200 as illustrated in FIG. 2 according to some embodiments of the present disclosure.

As illustrated in FIG. 3, in some embodiments, before operating operation S210, the feature vector of each of the several original samples So are extracted by the feature extraction circuit 112 as illustrated in FIG. 1 first. Then, the classification circuit 114 as illustrated in FIG. 1 classifies the original samples So as easy samples Se and hard samples Sh according to the feature vector of each of the several original samples So. After the classification circuit 114 classifies the several original samples So as the easy samples Se and the hard samples Sh, operation S210 is performed.

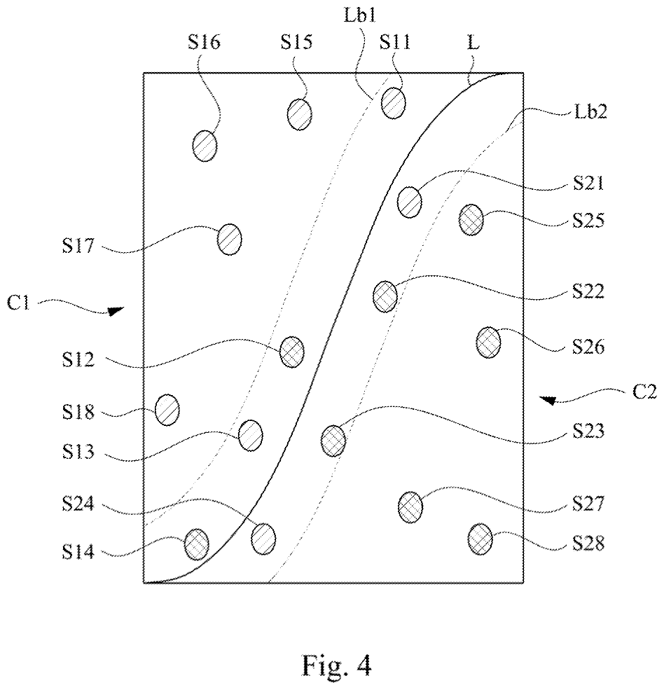

Reference is made to FIG. 4 together. FIG. 4 is a schematic diagram illustrating a sample classification according to some embodiments of the present disclosure. As illustrated in FIG. 4, the samples S11 to S18 located at the left side of the boundary L should be classified as type C1, and the samples S21 to S28 located at the right side of the boundary L should be classified as type C2.

The samples S15 to S18 and the samples S25 to S28 are easy samples Se. Since the easy samples Se are far away from the distance boundary L, the characteristics of the samples are relatively obvious, and the classification circuit 114 is less likely to make classification errors. Since the easy samples Se are less likely to be misclassified, the easy samples Se are all clean samples.

On the other hand, the samples S11 to S14 are the hard samples Sh located between the boundary Lb1 and the boundary L, and the samples S21 to S24 are the hard samples Sh located between the boundary Lb2 and the boundary L. Since samples S11 to S14 and samples S21 to S24 are relatively close to the boundary L, when the classification circuit 114 performs classification, the classification circuit 114 may classify incorrectly because the characteristics of the samples S11 to S14 and the samples S21 to S24 are relatively unobvious. For example, the classification circuit 114 classifies the samples S21 and S24 as type C1, and the classification circuit 114 classifies the samples S12 and S14 as type C2.

In some embodiments, for the samples classified as type C1 by the classification circuit 114, the classification circuit 114 sets those samples to include the label of type C1. Similarly, for the samples classified as type C2 by the classification circuit 114, the classification circuit 114 sets those samples to include the label of type C2.

The type C1 and the type C2 as mentioned above are distinguished by the classification circuit 114 through the image recognition algorithm. How to classify the samples into type C1 and type C2 through image recognition algorithms is known to those with ordinary knowledge in the field and will not be described in detail here. In addition, three or more types are also within the embodiments of the present disclosure.

In some embodiments, the classification circuit 114 is further configured to classify the original samples So as easy samples Se or hard samples Sh according to the small loss criterion. In detail, the classification circuit 114 classifies the samples with loss lower than the loss threshold as easy samples Se, and the classification circuit 114 classifies the samples with loss not lower than the loss threshold as hard samples Sh according to the loss of the samples S11 to S18 and S21 to S28.

In some embodiments, the classification circuit 114 is further configured to adjust the loss threshold according to a set ratio value. The set ratio value is the ratio value of the easy samples Se to the original samples So. When the set ratio value is higher, the loss threshold is higher, so that the number of easy samples Se relative to the number of the original samples So can reach the set ratio value. On the contrary, when the set ratio value is lower, the loss threshold is lower, so that the number of easy samples Se relative to the number of original samples So does not exceed the set ratio value.

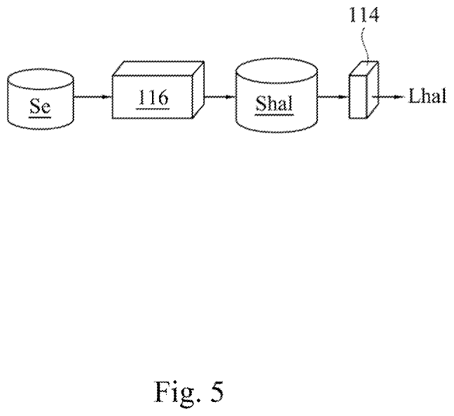

Reference is made to FIG. 5 together. FIG. 5 is a schematic diagram illustrating a generation of hallucination hard anchors according to some embodiments of the present disclosure. As illustrated in FIG. 5, in some embodiments, the hallucination hard anchor generation circuit 116 generates the hallucination hard anchors Shal according to the easy samples Se. After generating the hallucination hard anchors Shal, the classification circuit 114 further classifies the hallucination hard anchors Shal, so as to classify the hallucination hard anchors Shal as type C1 or type C2, and the classification circuit 114 further calculates the loss functions Lhal of the hallucination hard anchors Shal.

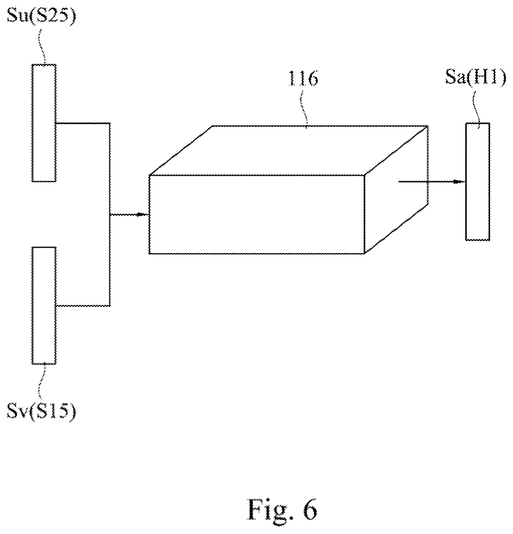

Reference is made to FIG. 6 together. FIG. 6 is a schematic diagram illustrating a generation of hallucination hard anchors according to some embodiments of the present disclosure. In an embodiment, the hallucination hard anchor generation circuit 116 is further configured to select at least two the easy samples. According to the at least one ratio value, the at least two easy samples are mixed, so as to generate one of the hallucination hard anchors. The at least two easy samples are classified as different types respectively. As illustrated in FIG. 6, the feature vector Su is a feature vector of the sample S25 of the type C2. The feature vector Sv is a feature vector of the sample S15 of the type C1. The hallucination hard anchor generation circuit 116 generates feature vector Sa according to the feature vector Su and the feature vector Sv. The feature vector Sa corresponds to the hallucination hard anchor H1.

In an embodiment, the hallucination hard anchor H1 includes first ratio value of the sample S25 and second ratio value of the sample S15. When the first ratio value is higher than second ratio value, the hallucination hard anchor generation circuit 116 sets the hallucination hard anchor H1 as the second type C2. That is, the same type of the sample S25. That is to say, the hallucination hard anchor generation circuit 116 sets the hallucination hard anchor H1 to include the label of the type C2.

In some other embodiments, the hallucination hard anchor generation circuit 116 is further able to mix three or more samples selected from different types to generate the hallucination hard anchors, and the type of the sample with the highest ratio value is used as the type of the generated hallucination hard anchors.

In some embodiments, the hallucination hard anchor generation circuit 116 calculates the loss functions Lhal of the hallucination hard anchors Shal according to the following formula.

$$Lhal = Lclo + H ( Sa , Yu ) . \\ Lclo = - λ\_p 〈 Sa , Su 〉 - ( 1 - λ\_p ) 〈 Sa , Sv 〉 . \\ λ\_p ∈ [ 0.5 , 1. ] .$$

In the above mentioned formula, [symbol] Sa,Sv [symbol] is a cosine distance between the feature vector Sa and the feature vector Sv. [symbol] Sa,Su [symbol] is a cosine distance between the feature vector Sa and the feature vector Su. H(Sa, Yu) is a cross entropy loss calculation function of the feature vector Sa and label Yu(type C2) of the feature vector λ_p is a random parameter between 0.5 and 1.0.

In some embodiments, the hallucination hard anchor generation circuit 116 is further configured to update the hallucination hard anchor generation circuit 116 according to the loss functions Lhal of the hallucination hard anchors Shal.

In some embodiments, the easy samples Se are classified as several batches. The hallucination hard anchor generation circuit 116 is further configured to generate the hallucination hard anchors Shal and to update the hallucination hard anchor generation circuit 116 according to the batches.

For example, assume that the easy samples Se are classified as three batches, and each of the batches includes parts of the easy samples Se. The hallucination hard anchor generation circuit 116 first generates the hallucination hard anchors Shal of the first batch according to the easy samples Se of the first batch, calculates the loss functions Lhal, and then updates the hallucination hard anchor generation circuit 116 according to the loss functions Lhal. Then, the hallucination hard anchor generation circuit 116 generates the hallucination hard anchors Shal of the second batch according to the easy samples Se of the second batch, calculates the loss functions Lhal, and then updates the hallucination hard anchor generation circuit 116 according to the loss functions Lhal. Last, the hallucination hard anchor generation circuit 116 generates the hallucination hard anchors Shal of the third batch according to the easy samples Se of the third batch, calculates the loss functions Lhal, and then updates the hallucination hard anchor generation circuit 116 according to loss the function Lhal.

Reference is made back to FIG. 2. In operation S230, according to several hallucination hard anchors, the several hard samples are classified as several types. Parts of the hard samples are classified as several clean hard samples of the several types. Another parts of the hard samples which are not classified as several types are classified as the several noisy hard samples. In some embodiments, operation S230 is performed by the classification circuit 114 as illustrated in FIG. 1.

In some embodiments, the classification circuit 114 is further configured to obtain at least one hallucination hard anchor of the several hallucination hard anchors. The at least one distance between the at least one hallucination hard anchor and a first hard sample of the several hard samples is smaller than a distance threshold. According to at least one hallucination hard anchor, the classification circuit 114 classifies the first hard sample as one of the several types.

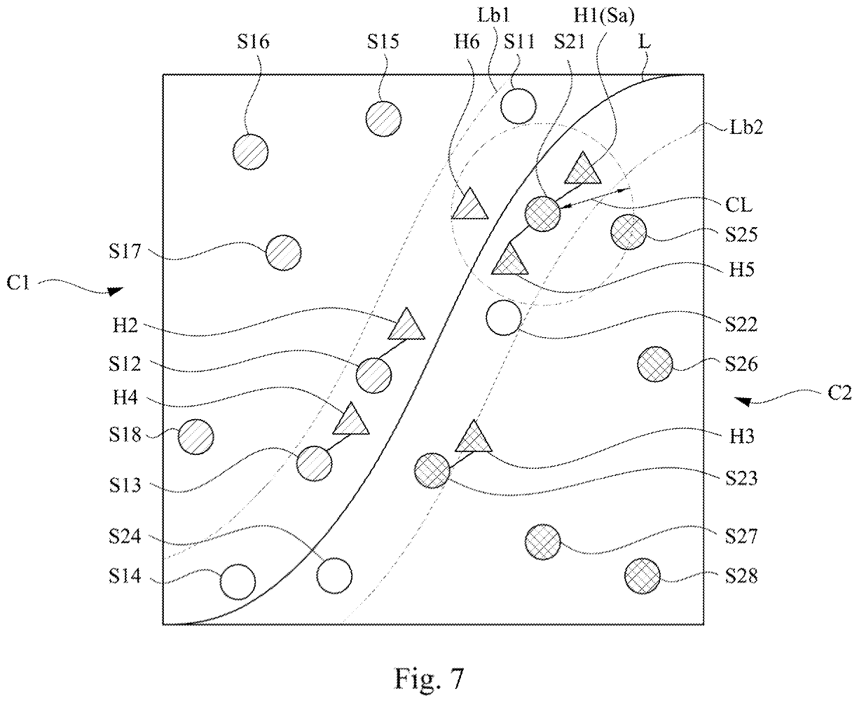

Reference is made to FIG. 7 together. FIG. 7 is a schematic diagram illustrating a sample classification according to some embodiments of the present disclosure. As illustrated in FIG. 7, for the sample S21, the hallucination hard anchors whose distance from the sample S21 is less than the distance threshold CL includes the hallucination hard anchors H1, H5 and H6. The hallucination hard anchors H1 and H5 are classified as type C2, the hallucination hard anchor H6 is classified as type C1. Since among the hallucination hard anchors H1, H5 and H6, there are more hallucination hard anchors of type C2, therefore, the classification circuit 114 classifies the sample S21 as type C2.

In some embodiments, when the distance between the hard samples Sh and every one of the hallucination hard anchors is not less than the distance threshold CL, the hard samples Sh will not be classified as type C1 or type C2. Or, when the number of hallucination hard anchors whose distance from the hard samples Sh is less than the distance threshold CL is less than the number threshold (for example, less than 3), the hard samples Sh will not be classified as type C1 or type C2. The classification circuit 114 determines the above hard samples Sh that is not classified as type C1 or type C2 as noisy hard samples Shn.

On the other hand, for the hard samples Sh classified as type C1 or type C2, the classification circuit 114 determines the hard samples Sh as clean hard samples Shc.

In some embodiments, the above distance refers to the distance vector between feature vectors.

for example, among the hard samples S11 to S14 and S21 to S24 in FIG. 7, the samples S11, S22, S14, and S24 are noisy hard samples Shn, while the samples S12, S13, S22, and S23 are clean hard samples Shc.

In operation S250, according to several easy samples and several clean hard samples, the machine learning training is performed. In some embodiments, operation S250 is performed by the training circuit 118 as illustrated in FIG. 1.

Reference is made back to FIG. 3. In some embodiments, the easy samples Sc and the clean hard samples Shc (and the correct labels included therein) are input to the training circuit 118 so as to perform the machine learning training. The training circuit 118 further calculates the distance loss Loss according to the easy samples Sc and the clean hard samples Shc (and the correct labels included therein).

In some embodiments, the training circuit 118 includes a semi-supervised learning model, and the training circuit 118 further inputs the output of the semi-supervised learning model to the distance loss calculation model (not shown) to calculate the distance loss Loss. The distance loss Loss indicates the training efficacy of the training circuit 118.

In some embodiments, the feature extraction circuit 112 and classification circuit 114 are further configured to update the feature extraction circuit 112 and the classification circuit 114 according to the easy samples Sc and the clean hard samples Shc (and the correct labels included therein).

In summary, the embodiments of the present disclosure provides a machine learning training device, a machine learning training method and a non-transitory computer readable storage medium. Compared with the dimension of classifying the original samples into clean samples and noisy samples according to the small loss criterion, the embodiments of the present disclosure classify the original samples into easy samples and hard samples. Based on the identified easy samples, hallucination hard anchors are generated, and according to hallucination hard anchors, the valuable clean hard samples are identified from the hard samples, so as to make better use of the sample data to perform the machine learning training. By using easy samples and clean hard samples with correct labels to perform machine learning (deep neural network) training, the embodiments of the present disclosure achieve significant performance improvements compared to previous technologies.

In addition, it should be noted that in the operations of the above mentioned signal transmission method, no particular sequence is required unless otherwise specified. Moreover, the operations may also be performed simultaneously or the execution times thereof may at least partially overlap.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A machine learning training device, comprising:
a hallucination hard anchor generation circuit, configured to generate a plurality of hallucination hard anchors according to a plurality of easy samples, wherein the plurality of easy samples are classified as a plurality of types, wherein each of the plurality of hallucination hard anchors corresponds to one of the plurality of types;
a classification circuit, coupled to the hallucination hard anchor generation circuit, configured to classify a plurality of hard samples as the plurality of types according to the plurality of hallucination hard anchors, wherein parts of the plurality of hard samples which are classified as the plurality of types are a plurality of clean hard samples, wherein another parts of the plurality of hard samples which are not classified as the plurality of types are a plurality of noisy hard samples; and
a training circuit, coupled to the classification circuit, configured to perform a machine learning training according to the plurality of easy samples and the plurality of clean hard samples.

2. The machine learning training device of claim 1, wherein the classification circuit is further configured to classify a plurality of original samples as the plurality of easy samples and the plurality of hard samples according to a plurality of loss and a loss threshold of the plurality of original samples, wherein the machine learning training device further comprises:
a feature extraction circuit, coupled to the classification circuit, configured to extract a plurality of feature vectors of the plurality of original samples.

3. The machine learning training device of claim 1, wherein the hallucination hard anchor generation circuit is further configured to select at least two of the plurality of easy samples, and to mix at least two of the plurality of easy samples according to at least one ratio value, so as to generate one of the plurality of hallucination hard anchors, wherein the at least two of the plurality of easy samples are different types of the plurality of types.

4. The machine learning training device of claim 3, wherein a first hallucination hard anchor of the plurality of hallucination hard anchors comprises a first ratio value of a first easy sample and a second ratio value of a second easy sample, wherein the first easy sample is classified as a first type of the plurality of types, the second easy sample is classified as a second type of the plurality of types, wherein when the first ratio value is higher than the second ratio value, the first hallucination hard anchor is set to be the first type.

5. The machine learning training device of claim 1, wherein the hallucination hard anchor generation circuit is further configured to update the hallucination hard anchor generation circuit according to a plurality of loss functions of the plurality of hallucination hard anchors, wherein the plurality of easy samples are classified as a plurality of batches, wherein the hallucination hard anchor generation circuit is further configured to generate the plurality of hallucination hard anchors and to update the hallucination hard anchor generation circuit according to the plurality of batches.

6. The machine learning training device of claim 1, wherein the classification circuit is further configured to obtain at least one hallucination hard anchor of the plurality of hallucination hard anchors, wherein at least one distance between the at least one hallucination hard anchor and a first hard sample of the plurality of hard samples is smaller than a distance threshold, and the first hard sample is classified as one of the plurality of types according to the at least one hallucination hard anchor.

7. A machine learning training method, comprising:
generating a plurality of hallucination hard anchors according to a plurality of easy samples, wherein the plurality of easy samples are classified as a plurality of types, wherein each of the plurality of hallucination hard anchors corresponds to one of the plurality of types;
classifying a plurality of hard samples as the plurality of types according to the plurality of hallucination hard anchors, wherein parts of the plurality of hard samples which are classified as the plurality of types are a plurality of clean hard samples, wherein another parts of the plurality of hard samples which are not classified as the plurality of types are a plurality of noisy hard samples; and
performing a machine learning training according to the plurality of easy samples and the plurality of clean hard samples.

8. The machine learning training method of claim 7, further comprising:
classifying a plurality of original samples as the plurality of easy samples and the plurality of hard samples according to a plurality of loss and a loss threshold of the plurality of original samples; and
extracting a plurality of feature vectors of the plurality of original samples.

9. The machine learning training method of claim 7, wherein a first hallucination hard anchor of the plurality of hallucination hard anchors comprises a first ratio value of a first easy sample and a second ratio value of a second easy sample, wherein the first easy sample is classified as a first type of the plurality of types, the second easy sample is classified as a second type of the plurality of types, wherein the machine learning training method further comprises:
selecting at least two of the plurality of easy samples;
mixing at least two of the plurality of easy samples according to at least one ratio value so as to generate one of the plurality of hallucination hard anchors, wherein the at least two of the plurality of easy samples are different types of the plurality of types; and
setting the first hallucination hard anchor to be the first type when the first ratio value is higher than the second ratio value.

10. The machine learning training method of claim 7, wherein the plurality of easy samples are classified as a plurality of batches, wherein the machine learning training method further comprises:
updating a hallucination hard anchor generation circuit according to a plurality of loss functions of the plurality of hallucination hard anchors; and
generating the plurality of hallucination hard anchors and updating the hallucination hard anchor generation circuit according to the plurality of batches.

11. The machine learning training method of claim 7, further comprising:
obtaining at least one hallucination hard anchor of the plurality of hallucination hard anchors, wherein at least one distance between the at least one hallucination hard anchor and a first hard sample of the plurality of hard samples is smaller than a distance threshold; and
classifying the first hard sample as one of the plurality of types according to the at least one hallucination hard anchor.

12. A non-transitory computer readable storage medium, configured to store a computer program, wherein when the computer program is executed, one or more processors are executed to perform a plurality of operations, wherein the plurality of operations comprise:
generating a plurality of hallucination hard anchors according to a plurality of easy samples, wherein the plurality of easy samples are classified as a plurality of types, wherein each of the plurality of hallucination hard anchors corresponds to one of the plurality of types;
classifying a plurality of hard samples as the plurality of types according to the plurality of hallucination hard anchors, wherein parts of the plurality of hard samples which are classified as the plurality of types are a plurality of clean hard samples, wherein another parts of the plurality of hard samples which are not classified as the plurality of types are a plurality of noisy hard samples; and
performing a machine learning training according to the plurality of easy samples and the plurality of clean hard samples.

13. The non-transitory computer readable storage medium of claim 12, wherein a first hallucination hard anchor of the plurality of hallucination hard anchors comprises a first ratio value of a first easy sample and a second ratio value of a second easy sample, wherein the first easy sample is classified as a first type of the plurality of types, the second easy sample is classified as a second type of the plurality of types, wherein the plurality of operations further comprise:
selecting at least two of the plurality of easy samples;
mixing at least two of the plurality of easy samples according to at least one ratio value so as to generate one of the plurality of hallucination hard anchors, wherein the at least two of the plurality of easy samples are different types of the plurality of types; and
setting the first hallucination hard anchor to be the first type when the first ratio value is higher than the second ratio value.

14. The non-transitory computer readable storage medium of claim 12, wherein the plurality of operations further comprise:
obtaining at least one hallucination hard anchor of the plurality of hallucination hard anchors, wherein at least one distance between the at least one hallucination hard anchor and a first hard sample of the plurality of hard samples is smaller than a distance threshold; and
classifying the first hard sample as one of the plurality of types according to the at least one hallucination hard anchor.
